(19) United States
(12) Patent Application Publication
(10) Pub. No.: US 2016/0201559 A1
(43) Pub. Date: Jul. 14, 2016

(54) TUBULAR COMBUSTION CHAMBER HAVING A FLAME TUBE END REGION AND GAS TURBINE

(71) Applicant: SIEMENS AKTIENGESELLSCHAFT, München (DE)

(72) Inventor: Matthias Hase, Mulheim (DE)

(73) Assignee: Siemens Aktiengesellschaft, Munich (DE)

(21) Appl. No.: 14/914,933

(22) PCT Filed: Aug. 26, 2014
(86) PCT No.: PCT/EP2014/068060

§ 371 Date: Feb. 26, 2016

(30) Foreign Application Priority Data
Sep. 9, 2013 (EP) 13183555.5

(51) Int. Cl. F02C 7/18; F23R 3/46; F23R 3/02

(52) U.S. Cl. CPC F02C 7/18; F23R 3/02; F23R 3/46

(57) ABSTRACT

A tubular combustion chamber for a gas turbine has a combustion chamber head end, on which at least one first burner arrangement is arranged, a substantially cylindrical flame tube, which encloses a first combustion zone and includes a cylindrical flame tube end region, and a transition duct, the cylindrical flame tube end region projecting into the transition duct and the transition duct fluid-connecting the flame tube to a combustion chamber outlet, which can be arranged on a turbine inlet region, wherein the cylindrical flame tube end region has a number of cooling ducts, which run substantially parallel to the lateral face of the flame tube end region in the interior of the flame tube end region. The cooling ducts are configured and/or arranged such that on average less cooling air flows through regions under low thermal load than through regions under high thermal load of the flame tube end region.

### CROSS REFERENCE TO RELATED APPLICATIONS

This application is the US National Stage of International Application No. PCT/EP2014/068060 filed 26 Aug. 2014, and claims the benefit thereof. The International application claims the benefit of European Application No. EP13183555 filed 9 Sep. 2013. All of the applications are incorporated by reference herein in their entirety.

### FIELD OF INVENTION

The invention relates to a tubular combustion chamber of a gas turbine and to a housing component of the tubular combustion chamber. The housing component takes the form of a flame tube end region.

### BACKGROUND OF INVENTION

In the simplest case, a gas turbine comprises a compressor for providing compressed air, at least one combustion chamber and a turbine.

To introduce fuel into the interior of the combustion chamber, the combustion chamber comprises at least one burner. The fuel introduced into the combustion chamber is reacted with the combustion air provided by the compressor in at least one combustion zone of the combustion chamber to produce a hot working gas.

The hot working gas sets the turbine in rotation, such that a shaft is driven. Some of the rotational energy transmitted to the shaft serves to drive the compressor. The rest of the rotational energy may be used to drive a driven/driving machine, in particular a generator.

The inner housing of the combustion chamber, which directly surrounds the interior of the combustion chamber, is exposed to high heat input, in particular in the region of the at least one combustion zone.

### SUMMARY OF INVENTION

The invention relates to a tubular combustion chamber with a combustion chamber head end, at which a burner device is arranged. The tubular combustion chamber comprises a flame tube with a cylindrical end region, said flame tube extending as far as a transitional region and being substantially cylindrical in shape. The cylindrical end region may also be denoted a “cooling ring”. The flame tube substantially encloses the combustion zone of the burner device. The tubular combustion chamber may comprise further burner arrangements, which introduce fuel into downstream combustion zones. The cylindrical flame tube end region projects into a component part of the tubular combustion chamber housing which serves to transfer the hot gases flowing out of the flame tube to the turbine and comprises an upstream inlet region and a downstream outlet region, wherein the inlet region of the transfer piece may generally have a circular cross-section and the outlet region of the transfer piece may be conformed to the outline of a ring segment. For the purposes of the present invention, the transfer piece will be designated “transition”. The flame tube may also be denoted “basket”. It is known from the prior art to provide the cylindrical end region of the flame tube with cooling air ducts, since it is exposed to particularly high heat input from the burner flames. The cooling air ducts extend substantially parallel to the circumferential surface of the cylindrical end region, i.e. in the interior of the flame tube end region. The direction of extension of the cooling air ducts may for example run parallel to a main direction of flow or longitudinal axis of the flame tube. The inlet openings of the cooling air ducts are located at the outside of the flame tube. The outlet openings of the cooling air ducts are arranged such that the cooling air is introduced into the interior of the combustion chamber. The outlet openings may in particular be located on the inside of the flame tube or at the downstream end face of the end region. An increase in the amount of cooling air flowing through the cylindrical flame tube end region improves cooling of this component. However, this causes an unfavorable increase in NOx pollutant emissions, since the cooling air cannot be used as combustion air, and an unfavorable increase in CO, since the cold air from the cooling air ducts generates cold strands in the combustion chamber, such that the CO burn-out reactions are braked in these regions. This is conventionally known as “quenching” of the CO burn-out reaction.

The invention is based on a tubular combustion chamber of the type in question, which comprises at least one first burner device at a combustion chamber head end, has a substantially cylindrical flame tube (which encloses a first combustion zone and comprises a cylindrical flame tube end region), and—a transfer duct, the cylindrical flame tube end region projecting into the transfer duct and the transfer duct connecting the flame tube fluidically with a combustion chamber outlet which may be arranged at a turbine inlet region,—the cylindrical flame tube end region comprising a number of cooling ducts, which run substantially parallel to the circumferential surface of the flame tube end region in the interior of the flame tube end region.

It is an object of the present invention to provide a tubular combustion chamber of the type in question, with which pollutant emissions may be reduced.

The object is achieved according to the invention for a tubular combustion chamber of the type in question in that the configuration and/or arrangement of the cooling ducts in the flame tube end region is such that on average less cooling air flows through regions exposed to lower thermal load than regions of the flame tube end region exposed to higher thermal load.

The configuration according to the invention of the cooling ring allows cooling air savings to be made, it thus being available as combustion air for reducing NOx. At the same time, the colder regions in the interior of the combustion chamber do not then continue to be cooled unnecessarily with cooling air from the cooling ring, such that according to the invention a reduction in CO pollutant emissions is also brought about. Since savings are made in the number of cooling ducts or the amount of cooling air only in the regions of the cooling ring which are exposed to lower thermal load, sufficient cooling of the component may be ensured despite the reduction in the amount of cooling air.

Advantageous configurations of the invention are indicated in the following description and the subclaims, the features of which may be applied individually and in any desired combination.

Provision may advantageously be made for the burner arrangement at the combustion chamber head end to comprise a number of burners, which are arranged annularly around the circumference of the combustion chamber, such that during operation a region of the flame tube exposed to higher thermal load and widening in the direction of flow is formed downstream of each burner, said region extending as far as into the flame tube end region of the flame tube, wherein the regions between the regions exposed to higher thermal load are exposed to lower thermal load.

The regions of the flame tube exposed to higher thermal load downstream of the burner outlets may be substantially triangular. The burner arrangement may consist of a centrally arranged pilot burner and a number of main swirlers. The main swirlers may be arranged in a ring around the pilot burner, wherein each main swirler comprises a (preferably cylindrical) premixing section surrounded by a housing and having a centrally arranged burner lance extending in the direction of flow. To generate swirl of the fluid flowing through the premixing section, swirl impellers are arranged in the premixing section which may be supported on the burner lance and may extend as far as the housing surrounding the premixing section. The outlet opening of the premixing section may be designated burner outlet.

It is advantageously further possible for the cooling ducts to extend substantially parallel to a longitudinal axis of the combustion chamber.

This arrangement of the cooling ducts has lower manufacturing costs. The cooling ducts may be straight bores, which may be produced by various manufacturing processes (for example drilling, spark erosion or for example electrochemical removal).

It may also be considered advantageous for at least one cooling duct arranged in a region exposed to higher thermal load to have a larger diameter than one of the cooling ducts in a region of the flame tube end region exposed to lower thermal load.

This allows the invention to be implemented for example with cooling ducts distributed evenly around the circumference. According to the invention, the diameters thereof may be selected to be larger in regions exposed to higher thermal load than in the regions exposed to lower thermal load. All or just some of the cooling air ducts could for example be configured with larger diameters in the regions exposed to higher thermal load.

According to a further advantageous configuration of the invention, which may also advantageously be combined with the previous configuration, the cooling ducts may be on average at a smaller distance from the directly adjacent cooling ducts in at least one region exposed to higher thermal load than in at least one region exposed to lower thermal load.

The tools for introducing the cooling ducts into the cooling ring may be arranged on a ring with the appropriate spacings, such that production of the ducts may proceed in parallel. The cooling ring has then to be fastened to the flame tube with appropriate orientation relative to the burners.

It may also be considered advantageous for the cylindrical flame tube end region to be composed of at least two cylindrical sub-regions, which are in each case joined together at a cut face extending perpendicular to the cylinder axis, wherein at least one cooling duct extending in a region exposed to lower thermal load is continued in a straight line through the cut face and/or at least one duct extending in a region exposed to higher thermal load is assembled from a cooling duct in the sub-region arranged upstream, which sub-region is connected fluidically via a cooling duct portion extending along the cut face with at least one cooling duct extending in the sub-region arranged downstream.

The assembled cooling ducts have the advantage that the regions exposed to higher thermal load and in general widening downstream may be better supplied, since the cooling ducts may follow the shape of the region. Use of the at least two-part cooling ring additionally makes it possible to introduce a different number of cooling ducts in the parts of the cooling ring, wherein downstream of the cut face a plurality of cooling ducts adjoin one upstream cooling duct. To this end, a groove introduced into the cut face (the groove may be introduced into both end faces or just one end face of the sub-regions of the flame tube end region) connects the upstream cooling duct with the at least one downstream cooling duct.

By means of at least one such assembled cooling duct, a number of cooling ducts in particular follows the profile of a region exposed to higher thermal load which widens in the main direction of flow.

This enables cooling of the region exposed to higher thermal load.

Provision may advantageously also be made for the assembled cooling ducts to fan out at the cut face into at least two cooling ducts.

This enables particularly uniform cooling of the region exposed to higher thermal load.

So that the cooling duct portion does not define the distribution of the cooling air over the fanned out cooling ducts, provision may advantageously be made for the cross-sectional area of the cooling duct portion extending along the cut face to be at least twice that of the respective cross-sectional areas of the at least two cooling ducts adjoining the cooling duct portion downstream. The cross-sectional area is in particular substantially three times the cross-sectional area of the cooling ducts adjoining downstream.

It is a further object of the invention to provide a flame tube end region of the above-mentioned tubular combustion chamber with which pollutant emissions may be reduced.

The object is achieved according to the invention for a flame tube end region of the stated type in that it is a component of the tubular combustion chamber according to the claims.

It is a further object of the invention to provide a gas turbine having at least one above-stated tubular combustion chamber with which pollutant emissions may be reduced.

The object is achieved according to the invention for a gas turbine of the above-stated type in that it comprises at least one tubular combustion chamber according to the claims.

Further convenient configurations and advantages of the invention constitute the subject matter of the description of exemplary embodiments of the invention with reference to the figures of the drawings, wherein the same reference numerals refer to identically acting components.

### BRIEF DESCRIPTION OF THE DRAWINGS

In the drawings

FIG. 1 is a schematic representation of a longitudinal section through a gas turbine according to the prior art,

FIG. 2 is a schematic representation of a longitudinal section through a tubular combustion chamber according to the prior art,

FIG. 3 is a schematically highly simplified representation of a developed view of the flame tube according to the prior art,

FIG. 4 is a schematically highly simplified representation of a developed view of the flame tube with a flame tube end region configured in accordance with the invention, according to a first exemplary embodiment,

FIG. 5 is a schematically highly simplified representation of a developed view of the with a flame tube end region configured in accordance with the invention, according to a second exemplary embodiment

FIG. 6 is a schematically highly simplified representation of a developed view of the flame tube with a flame tube end region configured in accordance with the invention, according to a third exemplary embodiment.

### DETAILED DESCRIPTION OF INVENTION

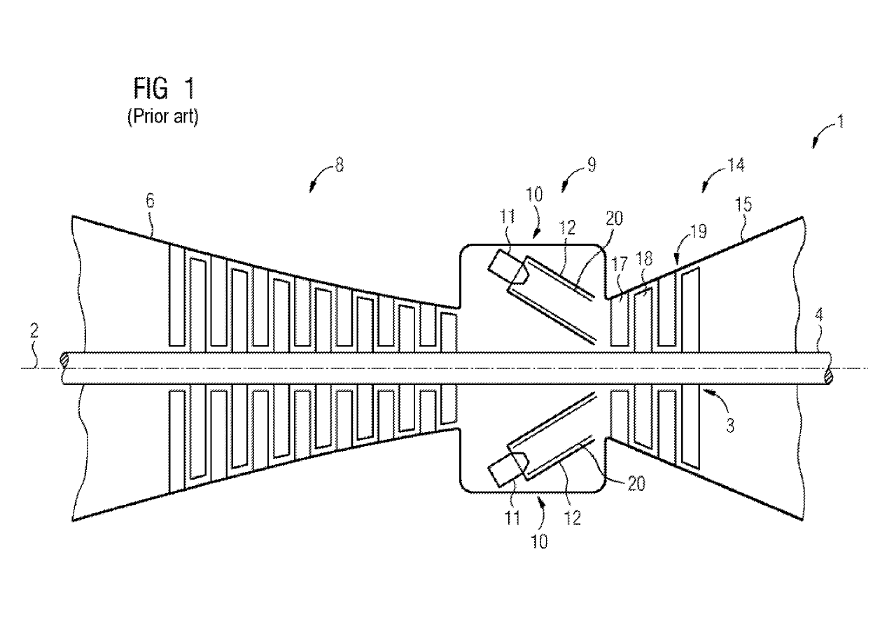

FIG. 1 shows a schematic sectional view of a gas turbine 1 according to the prior art. In its interior, the gas turbine 1 comprises a rotor 3 mounted so as to rotate about an axis of rotation 2 and having a shaft 4, said rotor also being known as a turbine wheel. The following succeed one another along the rotor 3: an intake housing 6, a compressor 8, a combustion system 9 with a number of combustion chambers 10, a turbine 14 and a waste gas housing 15. The combustion chambers 10 each comprise a burner arrangement 11 and a housing 12, which is lined with a heat shield 20 to provide protection from hot gases.

The combustion system 9 communicates with a for example annular hot gas duct. A plurality of series-connected turbine stages there form the turbine 14. Each turbine stage is formed of rings of blades or vanes. When viewed in the direction of flow of a working medium, a row formed of guide vanes 17 is followed by a row of rotor blades 18 in the hot duct. The guide vanes 17 are here fastened to an inner housing of a stator 19, whereas the rotor blades 18 of a row are mounted for example by means of a turbine disk on the rotor 3. A generator (not shown) is for example coupled to the rotor 3.

During operation of the gas turbine, air is drawn in by the compressor 8 through the intake housing 6 and compressed. The compressed air provided at the turbine-side end of the compressor 8 is guided to the combustion system 9 and there is mixed with a fuel in the region of the burner arrangement 11. The mixture is then combusted in the combustion system 9 with the assistance of the burner arrangement 11, forming a working gas stream. From there the working gas stream flows along the hot gas duct past the guide vanes 17 and the rotor blades 18. At the rotor blades 18 the working gas stream expands in a pulse-transmitting manner, such that the rotor blades 18 drive the rotor 3 and the latter drives the generator (not shown) coupled thereto.

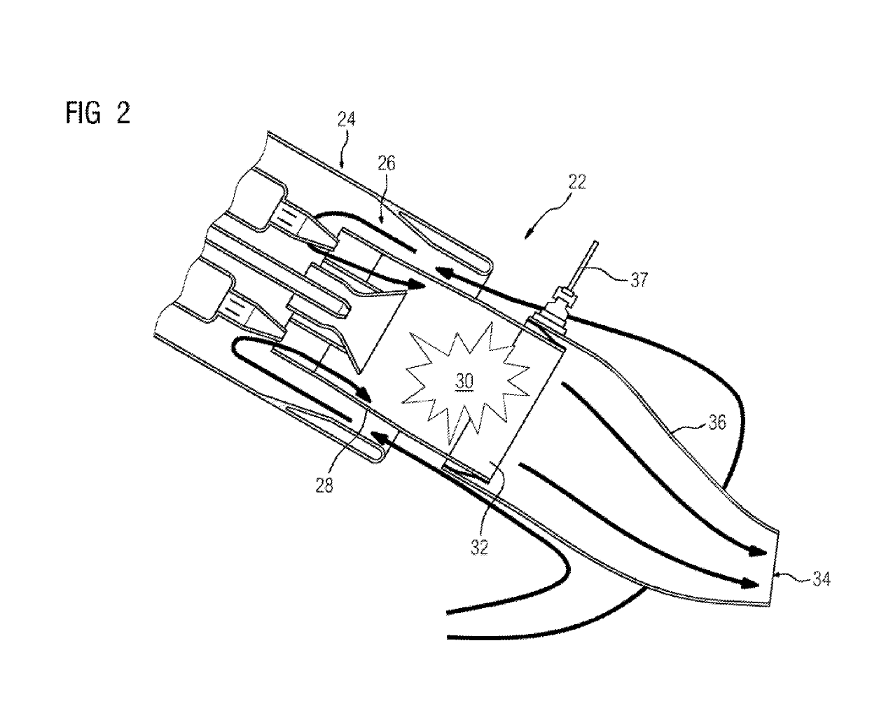

FIG. 2 shows a tubular combustion chamber 22 of a gas turbine. A burner arrangement 26 is arranged at the combustion chamber head end 24. This comprises a central pilot burner and a number of main burners arranged therearound. The burner arrangement opens into a flame tube 28 of cylindrical construction, which encloses a first combustion zone 30 and comprises a cylindrical flame tube end region 32. To connect the flame tube end region 32 fluidically with a combustion chamber outlet 34, a transfer duct 36 (transition) extends between the flame tube end region 32 and the combustion chamber outlet 34. The cylindrical flame tube end region projects into the transfer duct 36. In the transitional region between flame tube 28 and transfer duct there is an annular duct sealed by means of a spring seal, which prevents thermal stresses between the two components flame tube and transition. The transfer duct is fastened at its upstream end to an external housing (not shown) of the gas turbine by means of a retaining clip 37. Since the main burners each generate a flame in the first combustion zone 30 downstream of their burner outlets, the thermal load in the regions downstream of the burner outlets is greater than in the regions therebetween. The flame tube end region 32 is thus not uniformly thermally loaded around the circumference.

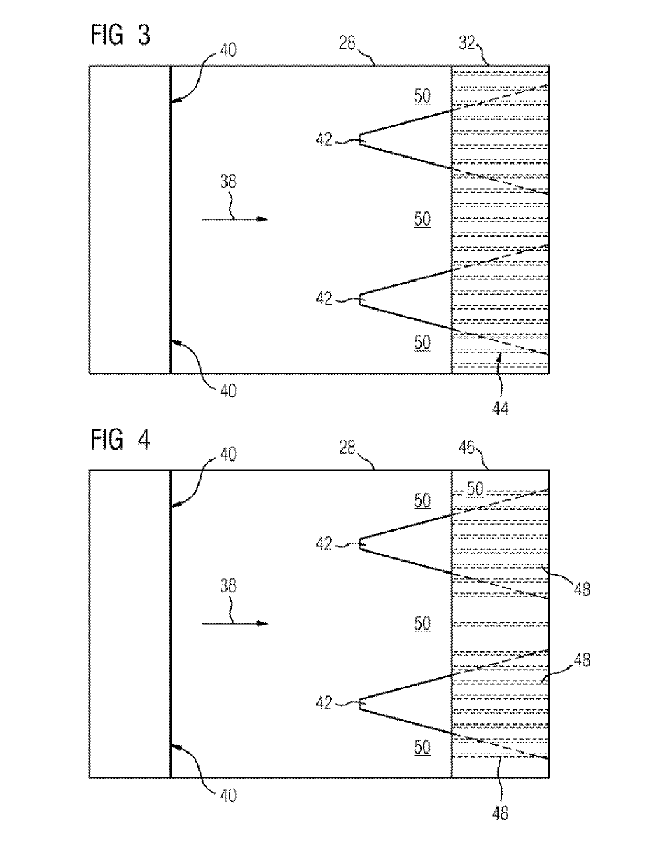

FIG. 3 shows a schematically highly simplified representation of a developed view of a flame tube 28 according to the prior art. A main direction of flow in the combustion chamber is indicated by the arrow 38, so as to be able to apply the terms upstream and downstream to FIG. 3. The region 40 indicates the burner outlets of two burners of the burner arrangement. The burners may be “main swirl generators”, which each comprise a premixing section, wherein the outlet of the premixing section may be designated burner outlet. Downstream of the burner outlets, widening regions 42 (here shown as triangular) of the flame tube form, which are exposed to higher thermal load (distinctly higher wall temperature). The cones indicate the increase in basket wall temperature as a result of the flame, which affects an ever greater circumference of the basket in the direction of flow. The representation is a diagram showing roughly the principle of the situation in the combustion system. The regions 42 extend as far as into the flame tube end region 32. The flame tube end region 32 has cooling ducts 44 passing through it, which extend parallel to the main direction of flow 38 and are uniformly spaced from one another. This results in uniform cooling of the component. As is clear, regions which do not experience an increased wall temperature are also cooled by the cooling ducts.

FIG. 4 shows a developed view of the flame tube 28 according to a first exemplary embodiment of the invention. The flame tube-end region 46 here comprises cooling ducts 48 extending parallel to the main direction of flow 38 (which extends parallel to a longitudinal axis of the combustion chamber). These are arranged according to the invention such that regions 50 exposed to lower thermal load have on average less cooling air flowing through them than regions 42 of the flame tube end region 46 exposed to higher thermal load. In the exemplary embodiment illustrated this is brought about in that the cooling ducts 48 in regions 42 exposed to higher thermal load are at a smaller distance from the directly adjacent cooling ducts 48 than those in the regions 50 exposed to lower thermal load. The same effect could be achieved if, for example, one or more cooling ducts arranged in a region 42 exposed to higher thermal load have a larger diameter than one or more cooling ducts 48 in the regions 50 exposed to lower thermal load of the flame tube end region 46. The cooling ducts are straight bores. The cooling air distribution is conformed, according to the invention, to the uneven distribution of the thermal load.

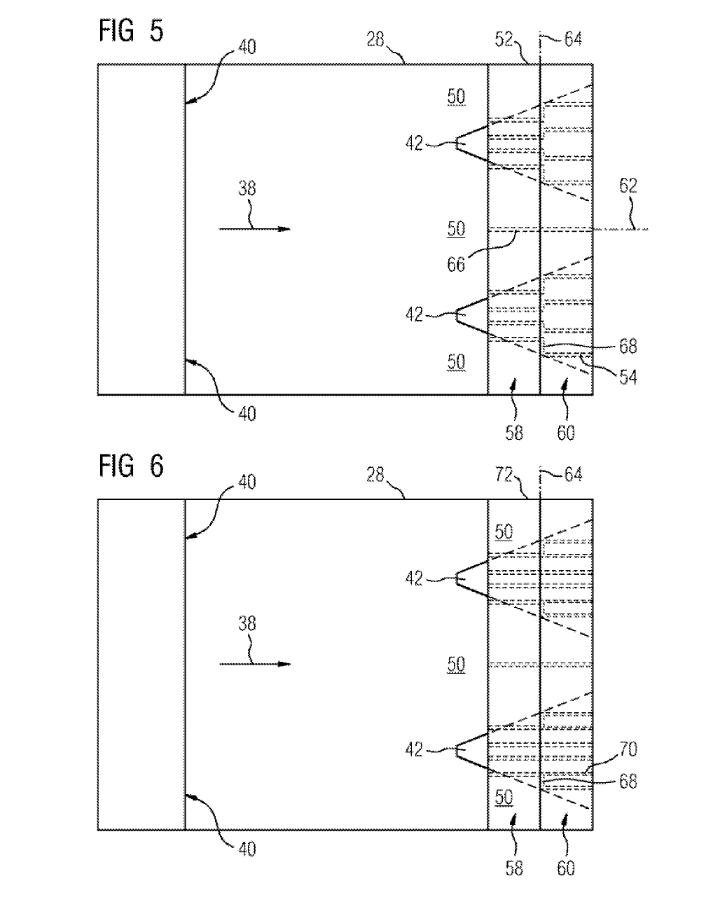

FIG. 5 shows a developed view of a flame tube 28 with a flame tube end region 52 according to a second exemplary embodiment of the invention. The flame tube end region 52 according to the invention is composed of two cylindrical sub-regions 58 and 60, which are each joined together at a cut face 64 extending perpendicular to the cylinder axis 62. Between the regions 42 exposed to higher thermal load the cooling ducts in the flame tube end region 52 in each case include one cooling duct 66 extending in a region 50 exposed to lower thermal load, which cooling duct 66 is continued in a straight line through the cut face 64. The flame tube end region 52 also comprises ducts 54 extending in the regions 42 exposed to higher thermal load, which ducts are assembled from a cooling duct in the upstream sub-region 58, which is connected fluidically with a cooling duct extending in the downstream sub-region 60 via a cooling duct portion 68 extending along the cut face 64. The configuration of the cooling ducts 54 is suitable for following the profile of the region 42 exposed to higher thermal load and widening downstream, whereby even in the sub-region 60 the regions 42 have cooling ducts passing through them over the entire width thereof. The cooling duct portion 68 may be formed by grooves in the end faces of the sub-regions defining the cut face.

FIG. 6 shows a third exemplary embodiment of the flame tube end region 72. The flame tube end region 72 differs from the exemplary embodiment shown in FIG. 5 in that the assembled cooling ducts 70 fan out into two cooling ducts (more than two is also possible) at the cut face 64 in the region 42 exposed to higher thermal load. In the exemplary embodiment shown in FIG. 6, the number of cooling ducts in the sub-region 60 is thus greater than in the sub-region 58.

This on the one hand has the advantage that the cooling ducts in the region 42 exposed to higher thermal load may be at the same distance from the directly adjacent cooling ducts (uniform cooling) in both sub-region 58 and sub-region 60. A further advantage is that by deflecting the flow of cooling fluid in the duct in the cooling duct portion 68, the thermal and hydrodynamic boundary layer of the cooling fluid is disturbed, which leads to an increase in heat transfer in the inlet zone of the cooling ducts in the downstream sub-region 60. (This further effect also arises with the assembled ducts of the previous figures). Thus, overheating of the regions 42 of the flame tube end region may be reliably avoided and cooling air savings made due to the lesser degree of cooling of the regions 50 exposed to lower load. In the example illustrated, care should be taken to ensure that the circumferential grooves in the cooling duct portions along the cut face do not define the air distribution over the cooling ducts in the sub-region 60. Of particular advantage is a cross-sectional area of the cooling duct which is around three times the respective cross-sectional area of the ducts adjoining downstream.

1.-11. (canceled)

12. A tubular combustion chamber for a gas turbine, comprising:
a combustion chamber head end, at which at least one first burner arrangement is arranged,
a substantially cylindrical flame tube, which encloses a first combustion zone and comprises a cylindrical flame tube end region, and
a transfer duct, the cylindrical flame tube end region projecting into the transfer duct and the transfer duct connecting the flame tube fluidically with a combustion chamber outlet which may be arranged at a turbine inlet region,
the cylindrical flame tube end region comprising a number of cooling ducts, which run substantially parallel to the circumferential surface of the flame tube end region in the interior of the flame tube end region,
the burner arrangement comprising at the combustion chamber head end a number of burners, which are arranged annularly around the circumference of the combustion chamber, such that during operation a region of the flame tube exposed to higher thermal load and widening in the direction of flow is formed downstream of each burner, said region extending as far as into the flame tube end region of the flame tube, wherein the regions between the regions exposed to higher thermal load are exposed to lower thermal load, the configuration and/or arrangement of the cooling ducts adapted such that less cooling air flows on average through regions exposed to lower thermal load than regions of the flame tube end region exposed to higher thermal load,
wherein the cylindrical flame tube end region is composed of at least two cylindrical sub-regions, which are each joined together at a cut face extending perpendicular to the cylinder axis, wherein at least one cooling duct extending in a region exposed to lower thermal load is continued in a straight line through the cut face and at least one duct extending in a region exposed to higher thermal load is assembled from a cooling duct in the sub-region arranged upstream, which sub-region is connected fluidically via a cooling duct portion extending along the cut face with at least one cooling duct extending in the sub-region arranged downstream.

13. The tubular combustion chamber as claimed in claim 12,
wherein the cooling ducts extend substantially parallel to a longitudinal axis of the combustion chamber.

14. The tubular combustion chamber as claimed in claim 12,
wherein at least one cooling duct arranged in a region exposed to higher thermal load has a larger diameter than one of the cooling ducts in a region of the flame tube end region exposed to lower thermal load.

15. The tubular combustion chamber as claimed in claim 12,
wherein the cooling ducts are on average at a smaller distance from the directly adjacent cooling ducts in at least one region exposed to higher thermal load than in at least one region exposed to lower thermal load.

16. The tubular combustion chamber as claimed in claim 12,
wherein a number of cooling ducts follows, by means of at least one such assembled cooling duct, the profile of a region exposed to higher thermal load which widens in the main direction of flow.

17. The tubular combustion chamber as claimed in claim 16,
wherein the assembled cooling ducts fan out into at least two cooling ducts downstream of the cut face.
